(19) United States
(12) Patent Application Publication
(10) Pub. No.: US 2006/0145638 A1
(43) Pub. Date: Jul. 6, 2006

(54) Control signals for single coil brushless motor

(76) Inventor: Sten R. Gerfast, Mendota Heights, MN (US)

Correspondence Address: STEN GERFAST, 1802 VALLEY CURVE, MENDOTA HEIGHTS, MN, 55118, US

(21) Appl. No.: 11/025,022

(22) Filed: Dec. 30, 2004

(51) Int. Cl. H02P 5/06

(52) U.S. Cl. 318/254

(57) ABSTRACT

Control signal generation for a direct current brushless motor having a single stator coil with two free ends and same number of stator poles as magnet poles. It is describing how to cost effectively generate control signals required for operation of the motor. This is done without Hall sensors by shunting the two free ends of the coil with a plurality of resistors and a plurality of steering diodes. These control signals together with rotation direction sensing is processed by a micro controller to energize the single motor coil both for correct starting and running.

### TECHNICAL FIELD

This invention relates to direct current brushless motors. Specifically it relates to a motor having a single stator coil with two free ends and same number of stator poles as magnet poles. It is describing how to cost effectively generate control signals required for starting and running without the use of separate Hall sensors or angular rotation sensors.

### BACKGROUND

Electrical motors require both a starting method and a running method. The most common motor, the induction motor, is operated on alternating current that is changing polarity at 60 or 50 hertz. This AC, or sine wave, that is applied to the stator, becomes the primary section of a rotating transformer. The rotor has cast-in aluminum bars that serve as the secondary (rotating) section of that transformer.

Since the induced current in all transformers are out of phase in the secondary, this out of phase current in the rotor bars repels/attracts the stator and makes the rotor both start and run. Induction motors do not require electronic circuitry to run.

Brushless motors are constructed differently with the rotor carrying a number of permanent magnets. Almost all related art brushless motors have a different number of wound stator poles versus magnet poles. All brushless motors are energized with direct current into the stator, that in turn repel/attracts the magnets on the rotor. But the DC current has to be applied at the appropriate angular position of the rotor to make the rotor start and run. This synchronization of current pulses to angular position can be done optically or magnetically, with the most common method being done with magnetic sensing Hall-sensors.

The vast majority of brushless motors are of the 3-phase type, meaning that it has the stator windings divided into three separate coils with 6 free ends.

These 3 coils can be connected “delta” or “Y”, but in either connection scheme, the DC current into the 3 coils has to be synchronized with the rotors correct angular position to be able to start and run. A somewhat representative related art is U.S. Pat. No. 6,204,617 with 3 separately wound coils connected in “Y” fashion with 6 transistors. And it is having both a sequencer and a processor to keep track of were the unequal number of magnets versus stator poles are. The timing or sync-pulse generation, in a 3 phase motor with rotation sensors, is normally achieved with 3 Hall sensors that magnetically senses the rotor position in front of each sensor and sequentially switch on the correct phase windings. Brushless motors of the 3 phase type normally has a different number of stator poles versus rotor poles. Current flows through two of the above mentioned 3 coils, at any one time. These two coils with 66% of the windings interacts with 2 thirds of the magnets on the rotor to produce torque for both starting and running, at any one time.

The common method of driving the coils is with 6 transistors.

The third coil can be utilized to generate a timing signal as soon as the rotor starts to rotate. This generation is best understood by remembering that any rotor with permanent magnets running, or turned by hand, in close proximity to stator windings will act as a generator of current. This generated timing signal can be used to replace the above mentioned 3 Hall sensors in a design of a so-called “sensor-less” 3 phase brushless motor.

But the problem remains that the timing signal does not appear until the rotor turns, so a start pulse has to be given to initiate rotation. And the other difficulty is that since there is neither a Hall sensor or angular rotor position sensor, that would instruct the start pulse device what polarity to switch on, the rotor can start up in either rotation direction.

A 3 phase brushless motor, common in the related art, does a checking of the polarity of the generated timing signal with a micro controller. If the polarity (and the rotation direction) is correct, the micro controller continues to sequence current pulses to all the windings for start and run. If the polarity is incorrect, the micro controller has to sense that fact, then correct the polarity, by polarity reversal and continue the correct sequence of pulses in order for the motor to start and run correctly. The complexity of sequencing all 3 windings with 6 transistors, either 3 Hall sensors or sensor-less problems mentioned above, makes the 3 phase motor both complex and expensive.

### THE PRESENT INVENTION

It is the object of the present invention to achieve control signals without angle rotation sensors thereby reducing both the complexity and the cost of both components and assembly.

Another object of the present invention is to eliminate the one Hall sensor required in a brushless motor that is designed according to patent application Ser.No. 10/462,008 Sten R. Gerfast titled SINGLE COIL, DIRECT CURRENT PERMANENT MAGNET BRUSHLESS MOTOR WITH VOLTAGE BOOST,

This motor has: A stator with a number of salient poles, each including alternately wound coils coupled to form a single coil with two free ends, and a commutated H-bridge, using only 4 transistors, that alternately turn on the single coil, and using a rotor with a like number of alternate polarity magnets rotatably journaled in the motor.

It is not a multi phase motor as described in the related art but a single coil with one Hall sensor. The single coil, with substantially 100% of the windings, interacts, at any one time, with all of the magnets on the rotor to produce torque for starting and torque for running. It requires timing or sync-pulse generation similar to the above mentioned prior related art, but with only a single coil to be turned on, it is only necessary to use a single Hall sensor. It is the object of the present invention to eliminate this single Hall sensor by using the coil itself with a plurality of resistors connected to the free ends, as sensing, in place of the Hall sensor.

The single coil is generating a signal, at the resistors, sometimes described as a back E.M.F. or fly back, whenever the rotor is moving, even after a minute angular rotation.

This signal, in the present invention, is used for sensing the rotation direction as well as creating a control signal for starting and running after interpreting by a micro controller.

A plurality of steering diodes will aid in rotation sensing.

Testing of the present invention has shown that is possible to generate the control signals in this simple manner. The micro controller can both interpret and measure phase angle as well as modify the timing of the generated back E.M.F in the single coil.

This type of sensing and generation of control signals appears to be unobvious judging by the fact that virtually all prior related art brushless motors sold the last 30 years, and those on the market today, are of the 3-phase multiphase type with complex sensing and driving.

The simple control sensing could be described as:

Controller for a single coil brushless motor comprising:

a stator and a rotor with equal number of salient poles,

an H-bridge commutating said coil by a micro controller receiving and interpreting back E.M.F signals from said coil achieving both correct starting and running of said motor.

It could also be described as:

Controller for a single coil brushless motor with H-bridge drive comprising:

A stator and a rotor with equal number of salient poles rotatably journaled in said motor, a commutated H-bridge alternately turning on said single coil, a pulse introduced into said coil for a pre-determined time, a micro controller sensing and interpreting the pulse in said coil during the sub-sequent rotation of said rotor, impelling said micro controller to send commands in a predetermined sequence to said H-bridge, achieving correct rotor rotation during starting and running.

It could also be described as:

Controller for a single coil brushless motor with H-bridge drive comprising:

A stator with a number of salient poles, each including alternately wound coils coupled to form a single coil with two free ends,

a commutatcd H-bridgc altcmatcly turning on said singlc coil,

a rotor with a like number of alternate polarity magnets poles, rotatably journaled in said motor,

a plurality of resistors connected to said free ends, a square wave generator initially introducing current into said coil for a pre-determined time, a micro controller sensing and interpreting the polarity of the generated signal in said resistors during the sub-sequent rotation of said rotor,

impelling said micro controller to send commands in a predetermined sequence to said H-bridge,

achieving correct rotor rotation during starting and running. The total sequence of sensing and interpreting as well as the sending of the correct commands is done in milli seconds.

The description and illustrations that are shown are by no means conclusive.

A person skilled in the art could easily make modifications, additions or alterations.

### BRIEF DESCRIPTION OF THE DRAWING

FIG. 1 discloses the single-coil brushless motor and motor controller according to present invention

### DETAILED DESCRIPTION OF THE DRAWING

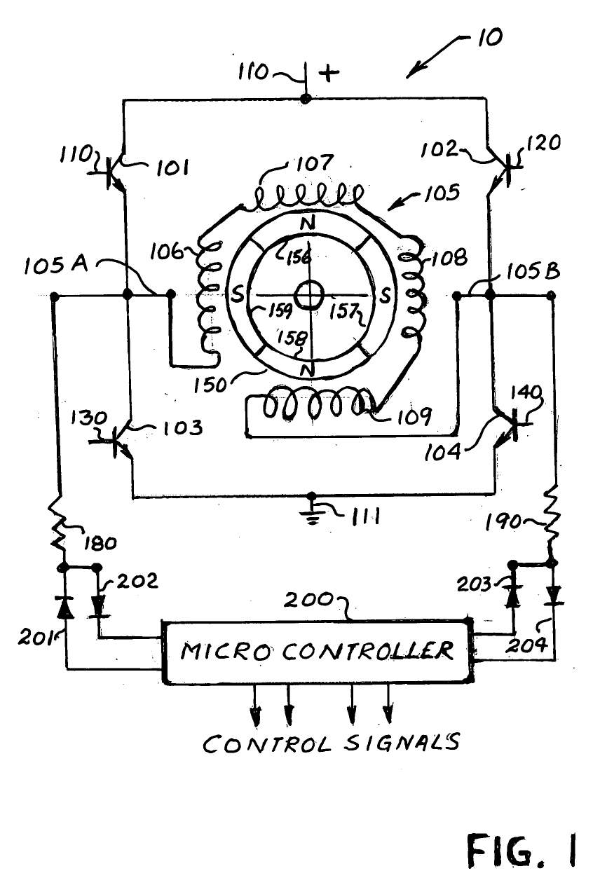

The circuit of FIG. 1 is showing a bridge circuit 10 having 4 transistors 101, 102, 103 and 104 and also is having a single coil 105 consisting of 4 separate, alternately wound, coil sections 106, 107, 108 and 109 coupled together to form single coil 105 with two free ends 105 A and 105 B that are connected between transistors 101 and 103 mid point and also connected between transistors 102 and 104 midpoint.

Transistors 101 and 102 are tied to a positive supply 110.

Transistors 103 and 104 are both grounded at point 111.

All four transistors are having gates 110, 120, 130 and 140 for connection to control signals. A rotor 150 is shown with 4 magnet poles 156, 157, 158 and 159 are shown in the center of stator coil 105. A resistor 180 is connected to free end 105 A and a second resistor 190 is connected to free end 105 B. The other end of both resistors are connected to micro controller 200 either directly or with steering diodes 201, 202, 203, and 204. The micro controller 200 has a minimum of 4 output terminals for control signals.

I claim:

1. Controller for a single coil brushless motor comprising:
a stator and a rotor with equal number of salient poles,
an H-bridge commutating said coil by a micro controller introducing pulses, receiving and interpreting back E.M.F signals from said coil achieving both correct starting and running of said motor.

2. Controller for a single coil brushless motor with H-bridge drive comprising:
A stator and a rotor with equal number of salient poles rotatably journaled in said motor,
a commutated H-bridge alternately turning on said single coil, a pulse introduced into said coil for a pre-determined time, a micro controller sensing and interpreting the pulse in said coil during the sub-sequent rotation of said rotor, impelling said micro controller to send commands in a predetermined sequence to said H-bridge, achieving correct rotor rotation during starting and running.

3. Controller for a single coil brushless motor with H-bridge drive comprising:
A stator with a number of salient poles, each including alternately wound coils coupled to form a single coil with two free ends,
said commutated H-bridge alternately turning on said single coil,
a rotor with a like number of alternate polarity magnets poles, rotatably journaled in said motor,
a square wave generator initially introducing current into said coil for a pre-determined time,
a micro controller sensing and interpreting the polarity of the generated signal in said coil during the sub-sequent rotation of said rotor,
committing said micro controller to send commands in a predetermined sequence to said H-bridge, achieving correct rotor rotation during starting and running.

4. The controller of claim 1 wherein the introducing, receiving, interpreting and and sending commands is accomplished in milliseconds.

5. The controller of claim 2 wherein the introducing, receiving, interpreting and and sending commands is accomplished in milliseconds.

6. The controller of claim 3 wherein the introducing, receiving, interpreting and and sending commands is accomplished in milliseconds.

7. The controller of claim 2 wherein determining of the correct rotation is done in milliseconds.

8. The controller of claim 3 wherein said H-bridge is also used as said square wave generator.

9. The controller of claim 1 wherein said H-bridge is powered by direct current or by rectified AC in combination with a smoothing capacitor.

10. The controller of claim 2 wherein locked rotor condition is sensed by said micro controller sensing an absence of polarity change in said coil.

11. The controller of claim 1 wherein said receiving and interpreting back E.M.F. signals are done with resistors combined with a plurality of steering diodes.
